(19) United States
(12) Patent Application Publication
(10) Pub. No.: US 2024/0126872 A1
(43) Pub. Date: Apr. 18, 2024

(54) LABELING METHOD FOR INFORMATION SECURITY DETECTION RULES AND TACTIC, TECHNIQUE AND PROCEDURE LABELING DEVICE FOR THE SAME

(71) Applicant: INSTITUTE FOR INFORMATION INDUSTRY, Taipei City (TW)

(72) Inventors: ZONG-JYUN LI, TAIPEI CITY (TW); SHENG-XIANG LIN, TAIPEI CITY (TW); DONG-JIE WU, TAIPEI CITY (TW)

(21) Appl. No.: 17/987,832

(22) Filed: Nov. 15, 2022

(30) Foreign Application Priority Data
Oct. 12, 2022 (TW) 111138541

(51) Int. Cl. G06F 21/55; G06F 21/62

(52) U.S. Cl. CPC G06F 21/554; G06F 21/6218; G06F 2221/034

(57) ABSTRACT

A labeling method for information security detection rules and tactic, technique and procedure (TTP) labeling device for the same are provided. The labeling method includes: obtaining reference documents related to definitions of TTP and classify the reference documents to generate corpuses; creating a keyword thesaurus; obtaining to-be-labeled detection rules, and extracting key information fields from the to-be-labeled detection rules and comparing the key information fields with keywords, so as to label the to-be-labeled detection rules; for the to-be-labeled detection rules that are not labeled, performing a text similarity calculation on the key information fields and the corpuses, and labeling those not labeled of the to-be-labeled detection rules with the corpus having the highest similarity; training with the labeled detection rules and the corpuses as a training data set to generate a TTP labeling model; and inputting a current to-be-labeled detection rule to generate a TTP labeling result.

### CROSS-REFERENCE TO RELATED PATENT APPLICATION

This application claims the benefit of priority to Taiwan Patent Application No. 111138541, filed on Oct. 12, 2022. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a labeling method and a labeling device, and more particularly to a labeling method for information security detection rules and a tactic, technique and procedure (TTP) labeling device for the same.

### BACKGROUND OF THE DISCLOSURE

As methods of attack involved in information security events become increasingly complicated; meanwhile, intrusion detection rules increase. In the existing threat detection and protection technologies for information security, a single-point detection based on intrusion indicators is mostly used, which may trigger a large number of alarms, making it difficult for analysts to deal with high-risk behaviors of a kill chain in real time and to understand intent of the attackers.

To assist the analysts to quickly learn the behaviors of the kill chain from the large number of alarms, an alarm correlation technology, as a defense method that utilizes tactic, technique, procedure (TTP) of the kill chain, is common and effective nowadays. Therefore, there is an urgent need for tools that can systematically and continuously perform TTP analysis on intrusion detection rules, so as to facilitate a multi-angle detection that includes point (intrusion indicators), line (kill chain), and surface (combined advanced persistent threat (APT)) against footprints and intentions of hackers.

### SUMMARY OF THE DISCLOSURE

In response to the above-referenced technical inadequacies, the present disclosure provides a labeling method for information security detection rules and a tactic, technique and procedure (TTP) labeling device for the same capable of rapidly expand a training data set and enhance an accuracy of TTP labeling.

In one aspect, the present disclosure provides a labeling method for information security detection rules, which is suitable for a tactic, technique and procedure (TTP) labeling device for information security protection, the TTP labeling device includes a processor and a storage unit, and the labeling method is executed by the processor and includes the following steps: obtaining a plurality of reference documents related to definitions of TTP, and classifying the reference documents according to tactic and technique to which the reference documents belong to, so as to generate a plurality of corpuses, in which the plurality of corpuses include a plurality of tactics and a plurality of techniques categorized according to the plurality of tactics; creating a keyword thesaurus that includes a plurality of keywords, in which tactics and/or techniques respectively corresponding to the plurality of keywords are defined in the keyword thesaurus; obtaining a plurality of to-be-labeled detection rules, and performing the following steps for the plurality of to-be-labeled detection rules to generate a plurality of labeled detection rules: extracting at least one key information field from the plurality of to-be-labeled detection rules; comparing the at least one key information field with the plurality of keywords, so as to label the plurality of to-be-labeled detection rules; for the to-be-labeled detection rules that are not labeled, obtaining a field content of the extracted at least one key information field, and performing a text similarity calculation on the field content and the plurality of corpuses to obtain a plurality of text similarities between the plurality of corpuses and the field content; and labeling the to-be-labeled detection rules that are not labeled with the tactics and the techniques corresponding to the corpus having a highest one of the text similarities. The labeling method further includes: using the labeled detection rules and the corpuses as a training data set, training a to-be-trained TTP labeling model to generate a TTP labeling model; and inputting a current to-be-labeled detection rule into the TTP labeling model to generate a TTP labeling result, and updating the corpuses with the TTP labeling result.

In another aspect, the present disclosure provides a tactic, technique and procedure (TTP) labeling device for information security detection rules, and the TTP labeling device includes a processor and a storage unit electrically connected to the processor. The processor is configured to perform the following steps: obtaining a plurality of reference documents related to definitions of TTP, and classifying the reference documents according to tactic and technique to which the reference documents belong to, so as to generate a plurality of corpuses, in which the plurality of corpuses include a plurality of tactics and a plurality of techniques categorized according to the plurality of tactics; creating a keyword thesaurus that includes a plurality of keywords, in which tactics and/or techniques respectively corresponding to the plurality of keywords are defined in the keyword thesaurus; obtaining a plurality of to-be-labeled detection rules, and performing the following steps for the plurality of to-be-labeled detection rules to generate a plurality of labeled detection rules: extracting at least one key information field from the plurality of to-be-labeled detection rules; comparing the at least one key information field with the plurality of keywords, so as to label the plurality of to-be-labeled detection rules; for the to-be-labeled detection rules that are not labeled, obtaining a field content of the extracted at least one key information field, and performing a text similarity calculation on the field content and the plurality of corpuses to obtain a plurality of text similarities between the plurality of corpuses and the field content; and labeling the to-be-labeled detection rules that are not labeled with the tactics and the techniques corresponding to the corpus having a highest one of the text similarities. The processor is further configured to perform the following steps: using the labeled detection rules and the corpuses as a training data set, training a to-be-trained TTP labeling model to generate a TTP labeling model; and inputting a current to-be-labeled detection rule into the TTP labeling model to generate a TTP labeling result, and updating the corpuses with the TTP labeling result.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a functional block diagram of tactic, technique and procedure (TTP) labeling device for information security detection rules according to one embodiment of the present disclosure;

FIG. 2 is a flowchart of a labeling method for information security detection rules according to one embodiment of the present disclosure;

FIG. 3 is a detailed flowchart of step S10 in FIG. 2;

FIG. 4 is a detailed flowchart of step S13 in FIG. 2;

FIG. 5 is a detailed flowchart of step S14 in FIG. 2

FIG. 6 is a detailed flowchart of step S16 in FIG. 2; and

FIG. 7 is a schematic diagram showing a training process of a to-be-trained TTP labeling model according to one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

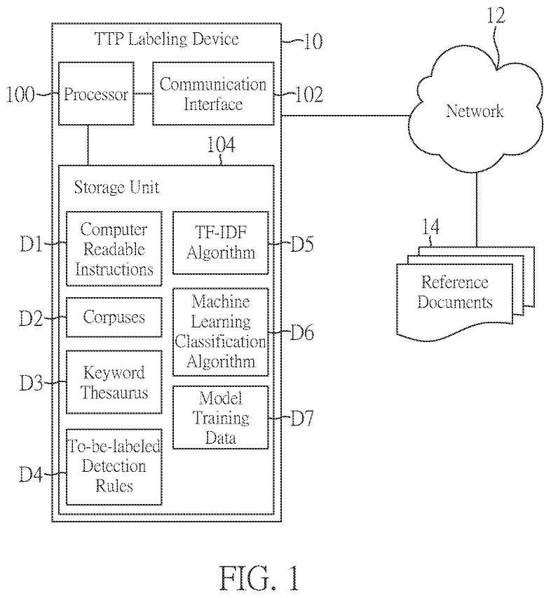

FIG. 1 is a functional block diagram of tactic, technique and procedure (TTP) labeling device for information security detection rules according to one embodiment of the present disclosure.

Reference is made to FIG. 1, one embodiment of the present disclosure provides a TTP labeling device 10, which includes a processor 100, a communication interface 102 and a storage unit 104. The processor 100 is coupled to the communication interface 102 and the storage unit 104. The storage unit 104 can be, for example, but not limited to, a hard disk, a solid-state hard disk, or other storage devices that can be used to store data, and is configured to store at least a plurality of computer-readable instructions D1, corpuses D2, a keyword thesaurus D3, to-be-labeled detection rules D4, a term frequency-inverse document frequency (TF-IDF) algorithm D5, a machine learning classification algorithm D6 and model training data D7. The communication interface 102 can be, for example, a network interface card that is configured to access a network 12 under control of the processor 100.

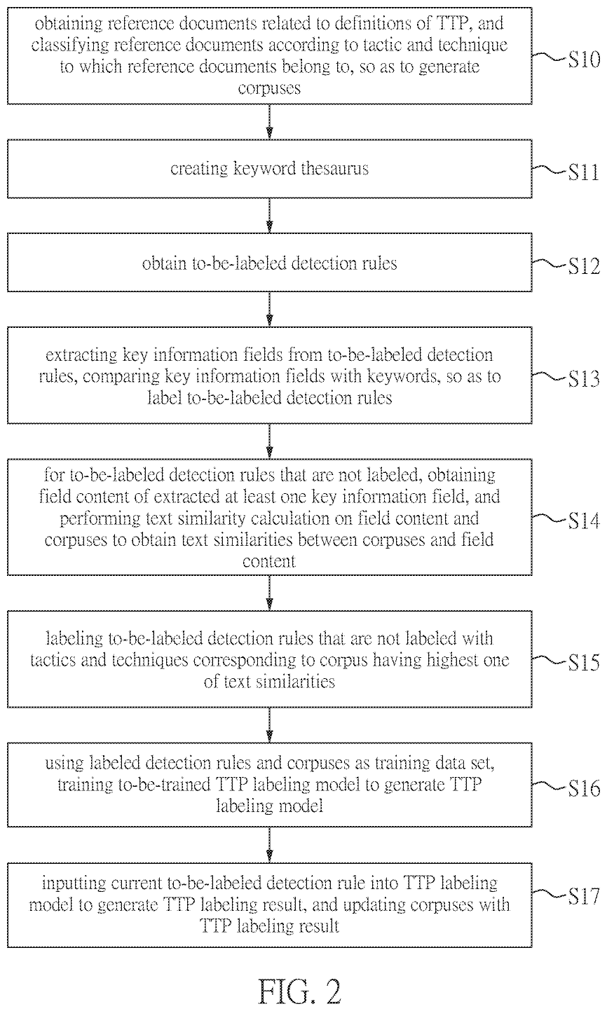

FIG. 2 is a flowchart of a labeling method for information security detection rules according to one embodiment of the present disclosure. Reference is made to FIG. 2, one embodiment of the present disclosure provides a labeling method for information security detection rules, which is suitable for the aforementioned TTP labeling device 10. The labeling method can include, in response to the processor 100 executing the plurality of computer-readable instructions D1, performing the following steps:

Step S10: obtaining a plurality of reference documents related to definitions of TTP, and classifying the reference documents according to tactic and technique to which the reference documents belong to, so as to generate a plurality of corpuses.

In detail, this step is to collect TTP definition content. For example, reference documents 14 provided by information security organizations (such as MITRE ATT&CK®)) for the definition of TTP can be collected through the network 12, and the content of groups of the reference documents 14 can be classified into data sets according to tactics and techniques to which the reference documents belong to. After step S10 is performed, the plurality of corpuses D2 corresponding to a plurality of tactics and a plurality of techniques can be obtained.

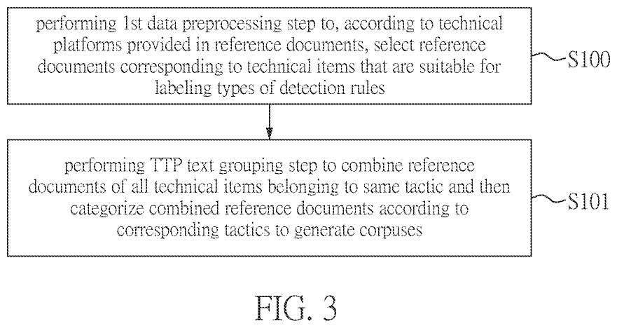

Reference is made to FIG. 3, which is a detailed flowchart of step S10 in FIG. 2.

As shown in FIG. 3, step S10 further includes: step S100 and step S101. Step S100: performing a first data preprocessing step to, according to technical platforms provided in the reference documents, select the reference documents corresponding to the plurality of technical items that are suitable for labeling types of detection rules.

Step S101: performing a TTP text grouping step to combine the reference documents of all the technical items belonging to the same tactic and then categorize the combined reference documents according to the corresponding tactics to generate the plurality of corpuses. In this case, the plurality of corpuses include a plurality of tactics and a plurality of techniques categorized according to the plurality of tactics.

In detail, in the embodiment of FIG. 3, the content of articles provided by an information security organization (such as MITRE) for defining TTPs can be obtained by means of a web crawler. The first data preprocessing step is then performed on the obtained content of the articles, so as to select technical items that are suitable for labeling types of detection rules. For example, a technology platform of the network-based intrusion detection system (NIDS) technology must be a network, and a technology platform of the host-based intrusion detection system (HIDS) technology must be Windows operating system. After the selection, the TTP grouping step is performed on the selected technical items to combine the reference documents of all the technical items (e.g., TTP definition articles) belonging to the same tactic, and then categorize the combined reference documents according to the corresponding tactics to generate the plurality of corpuses D2.

Step S11: creating a keyword thesaurus D3. In this step, the keyword thesaurus D3 including multiple keywords can be established through expert knowledge. Furthermore, in the keyword thesaurus D3, the tactics and/or techniques corresponding to the multiple keywords are defined, such correspondences can be used to determine the tactic and/or the technique in the subsequent steps.

Step S12: obtain a plurality of to-be-labeled detection rules D4. For example, the to-be-marked detection rules D4 can be obtained from the existing Snort and Suricata detection rules. Taking Snort detection rules as an example, Snort is a network-based intrusion detection system (NIDS) that can be used to detect abnormal packets on the network. Snort detection rules can be utilized to perform protocol analysis, search/match content and detect a variety of different attack methods, with immediate warning of attacks. These detection rules are developed in an open-sourced way that allows additional detection rules to be added.

Next, the following steps can be performed for the to-be-labeled detection rules D4 to generate a plurality of labeled detection rules.

Step S13: extracting key information fields from the plurality of to-be-labeled detection rules D4, comparing the key information fields with the plurality of keywords, so as to label the plurality of to-be-labeled detection rules D4.

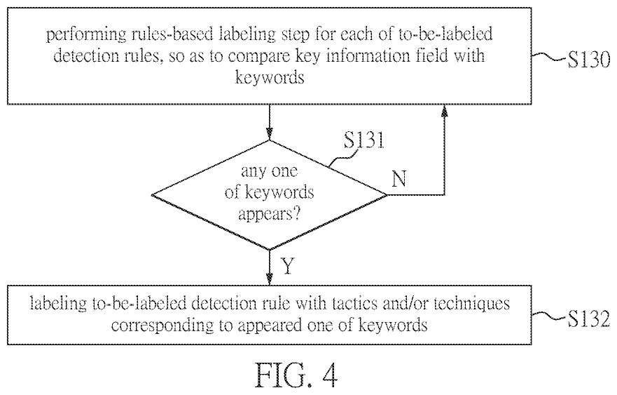

Reference is made to FIG. 4, which is a detailed flowchart of step S13 in FIG. 2.

As shown in FIG. 4, step S13 further includes steps S130 to S132. Step S130: performing a rules-based labeling step for each of the plurality of to-be-labeled detection rules D4, so as to compare the information field with the plurality of keywords. Step S131: determining whether or not any one of the keywords appears in one of the to-be-labeled detection rules. If the determination is affirmative, the labeling method proceeds to step S132: labeling the to-be-labeled detection rule with the tactics and/or techniques corresponding to the appeared one of the keywords. If the determination is negative, the labeling method proceeds back to step S130 to compare a next one of the to-be-labeled detection rules.

In detail, in step S131, whether or not there is any matched word in the key information field of one of the to-be-labeled detection rules D4 can be determined according to the keyword thesaurus D3 established in the previous step, and if so, the to-be-labeled detection rule having the matched word can be labeled according to the corresponding tactics and/or techniques defined by experts.

Reference is made back to FIG. 2 again. After the comparison performed in step S13, there may be certain to-be-labeled detection rules D4 that are not labeled, and thus the labeling method proceeds to step S14: for the to-be-labeled detection rules that are not labeled, obtaining field content of the extracted at least one key information field, and performing a text similarity calculation on the field content and the plurality of corpuses to obtain a plurality of text similarities between the plurality of corpuses and the field content. In detail, since terms used in the key information fields of the to-be-labeled detection rules D4 and in the corpuses D2 may sometimes have different parts of speech or abbreviations due to different text expressions, such that the comparison performed in step S13 may not thorough enough. Therefore, to-be-compared texts are further processed in this step to address this issue.

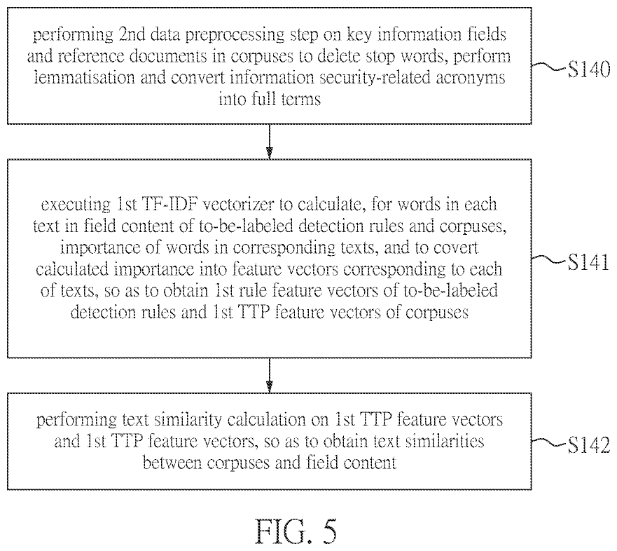

Reference is made to FIG. 5, which is a detailed flowchart of step S14 in FIG. 2.

Step S140: performing a second data preprocessing step on the key information fields and the reference documents in the corpuses to delete stop words, perform a lemmatisation and convert information security-related acronyms into full terms.

Step S141: executing a first TF-IDF vectorizer to calculate, for words in each text in the field content of the to-be-labeled detection rules and the corpuses, importance of the words in the corresponding texts, and to covert the calculated importance into feature vectors corresponding to each of the texts, so as to obtain a plurality of first rule feature vectors of the plurality of to-be-labeled detection rules D4 and a plurality of first TTP feature vectors of the plurality of corpuses. It should be noted that the TF-IDF algorithm D5 can be executed on the field content of the to-be-labeled detection rules D4 and the corpuses D2 to evaluate the importance of the words in the field content with respect to one of files in the corpuses D2.

Step S142: performing the text similarity calculation on the first TTP feature vectors and the first TTP feature vectors, so as to obtain the plurality of text similarities between the corpuses and the field content.

Reference is made to FIG. 2 again, after the calculation of step S14, the labeling method can proceed to step S15: labeling the to-be-labeled detection rules that are not labeled with the tactics and the techniques corresponding to the corpus having a highest one of the text similarities.

In order to continuously perform TTP labeling for detection rules in a systematic manner, it is necessary to overcome issues such as limited data sets and insufficient support for cross-information security protection applications. Since there is no public data set dedicated to the TTP labeling for intrusion detection rules, the TTP labeling can merely be performed manually, which leads to a limited quantity of labeling. Furthermore, the labeling technology needs to reduce its dependence on specific information security protection applications. However, regardless of limited TTP labeling data set, the labeling method provided by the present disclosure can assist experts in labeling a large quantity of information security detection rules. Therefore, in the labeling method provided by the present disclosure, a large quantity of data sets can be provided for training a machine learning model, and labeling results can be more reliable under TTP framework defined by the information security organization. After steps S13 to S15 are performed, the plurality of labeled detection rules can be obtained. These labeled detection rules can be verified by experts, then directly expanded to a training data set, and the training data set can be provided to a machine learning-based labeling model for training.

The labeling method proceeds to step S16: using the labeled detection rules and the corpuses as a training data set, training a to-be-trained TTP labeling model to generate a TTP labeling model.

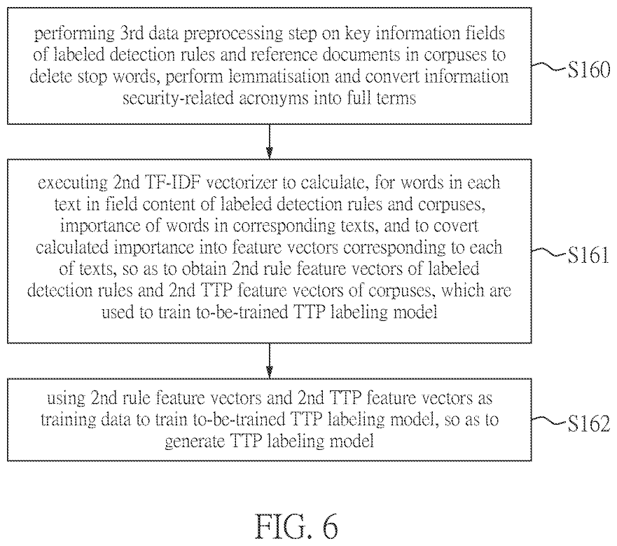

Further reference can be made to FIG. 6, which is a detailed flowchart of step S16 of FIG. 2.

Step S160: performing a third data preprocessing step on key information fields of the labeled detection rules and the reference documents in the corpuses to delete stop words, perform a lemmatisation and convert information security-related acronyms into full terms.

Step S161: executing a second TF-IDF vectorizer to calculate, for words in each text in the field content of the labeled detection rules and the corpuses, importance of the words in the corresponding texts, and to covert the calculated importance into feature vectors corresponding to each of the texts, so as to obtain a plurality of second rule feature vectors of the labeled detection rules and a plurality of second TTP feature vectors of the plurality of corpuses, which are used to train the to-be-trained TTP labeling model.

It should be noted that the to-be-trained TTP labeling model can be, for example, the machine learning classification algorithm D6, and can be, for example, a support vector machine (SVM) as a main body of the model. During the training process, step S162 can be executed: using the second rule feature vectors and the second TTP feature vectors as training data to train the to-be-trained TTP labeling model, so as to generate the TTP labeling model.

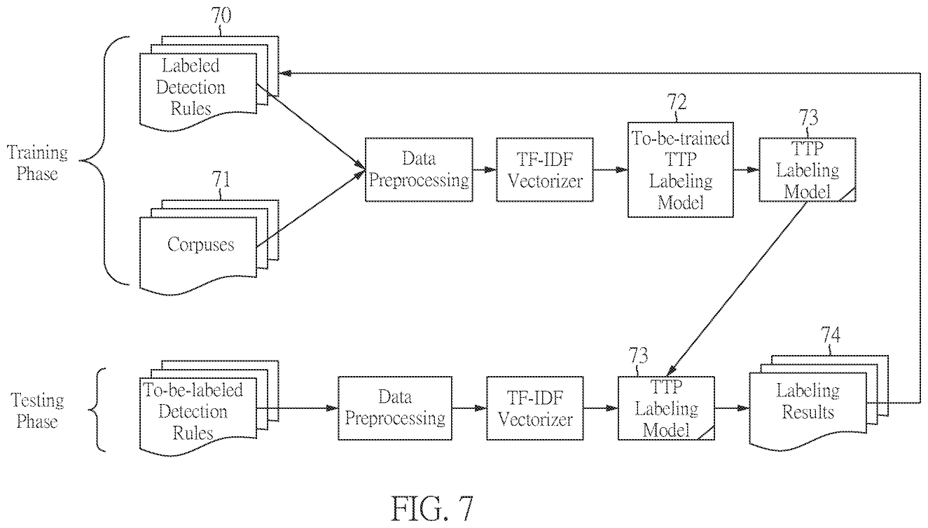

Reference is made to FIG. 7, which is a schematic diagram showing a training process of a to-be-trained TTP labeling model according to one embodiment of the present disclosure. As mentioned in the step S162, in a training phase, the labeled detection rules 70 and the corpus 71 are used as training data sets (which can be stored as the model training data D7), and are converted into feature vectors by performing data preprocessing and utilizing a TF-IDF vectorizer. The to-be-trained TTP labeling model 72 is trained with the feature vectors, and a training result is stored as the TTP marking model 73.

Next, in a testing phase, the to-be-labeled rules obtained in the step S12 can be converted into feature vectors by performing the data preprocessing and the TF-IDF vectorizer, and the feature vectors are then input into the TTP labeling model 73 to generate labeling results 74, which are compared with labeling results of the labeled detection rules 70 to determine an accuracy. By repeating the above training phase and testing phase, in response to the accuracy reaching a target accuracy, the TTP labeling model 73 is taken for automatic labeling to-be-labeled detection rules provided afterward.

Step S17: inputting a current to-be-labeled detection rule into the TTP labeling model to generate a TTP labeling result, and updating the corpuses with the TTP labeling result. It should be noted that, in the labeling method of the present disclosure, the labeled detection rules can be used to expand the TTP corpuses through a feedback mechanism.

Reference is made to the following table I, which shows experimental results of the labeling method for information security detection rules provided by the present disclosure.

TABLE I

| Methods | Type of TTP | Precision | Recall | F1-Score |
|---|---|---|---|---|
| The present | Tactics | 96.1% | 96.64% | 96.18% |
| disclosure | Techniques | 94% | 94.47% | 94.12% |
| rcATT | Tactics | 77.09% | 68.4% | 56.86% |
| | Techniques | 86.44% | 15.06% | 22.03% |

As shown in Table I, the labeling method for information security detection rules provided by the present disclosure, accuracy, recall rate and F1-score evaluation index are all reach more than 94% in labeling tactics and techniques. Compared with rcATT technology used in a literature entitled “Automated Retrieval of ATT&CK Tactics and Techniques for Cyber Threat Reports” published by Valentine Legoy et al. in 2020, the labeling method of the present disclosure is apparently more suitable for the TTP labeling of detection rules with less key information for labeling.

In conclusion, in the labeling method for information security detection rules and the TTP labeling device for the same provided by the present disclosure, a large number of detection rules can be labeled effectively, and the labeling method and TTP labeling device can also be applied to detection rules for different information security protection applications, such that the analysts can be assisted to obtain more attack event information from the TTP labeled from a large number of alarms, to relate the attack events to a whole picture to grasp a current stage in specific hacker-attack operation.

Furthermore, in the labeling method for information security detection rules and the TTP labeling device for the same provided by the present disclosure, contents of TTP articles defined by information security organizations are used as references, and for the detection rules for information security protection applications (such as NIDS), correlations between each rule, tactic, and technique definition content are calculated by using the similarity algorithm, so as to assist experts to quickly label a large number of rules and accumulate TTP training data sets required for a subsequent machine learning phase.

Furthermore, in the labeling method for information security detection rules and the TTP labeling device for the same provided by the present disclosure, the labeling results can be used as the training data set to establish the TTP labeling model by executing the machine learning classification algorithm, so as to effectively improve labeling accuracy.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A labeling method for information security detection rules, which is suitable for a tactic, technique and procedure (TTP) labeling device for information security protection, the TTP labeling device including a processor and a storage unit, and the labeling method being executed by the processor and comprising the following steps:
obtaining a plurality of reference documents related to definitions of TTP, and classifying the reference documents according to tactic and technique to which the reference documents belong to, so as to generate a plurality of corpuses, wherein the plurality of corpuses include a plurality of tactics and a plurality of techniques categorized according to the plurality of tactics;
creating a keyword thesaurus that includes a plurality of keywords, wherein tactics and techniques respectively corresponding to the plurality of keywords are defined in the keyword thesaurus;
obtaining a plurality of to-be-labeled detection rules, and performing the following steps for the plurality of to-be-labeled detection rules to generate a plurality of labeled detection rules:
extracting at least one key information field from the plurality of to-be-labeled detection rules;
comparing the at least one key information field with the plurality of keywords, so as to label the plurality of to-be-labeled detection rules;
for the to-be-labeled detection rules that are not labeled, obtaining field content of the extracted at least one key information field, and performing a text similarity calculation on the field content and the plurality of corpuses to obtain a plurality of text similarities between the plurality of corpuses and the field content; and
labeling the to-be-labeled detection rules that are not labeled with the tactics and the techniques corresponding to the corpus having a highest one of the text similarities;
using the labeled detection rules and the corpuses as a training data set, training a to-be-trained TTP labeling model to generate a TTP labeling model; and
inputting a current to-be-labeled detection rule into the TTP labeling model to generate a TTP labeling result, and updating the corpuses with the TTP labeling result.

2. The labeling method according to claim 1, further comprising:
performing a rules-based labeling step for each of the plurality of to-be-labeled detection rules, so as to compare the at least one key information field with the plurality of keywords; and
in response to any one of the plurality of keywords matching the at least one key information field, labeling the to-be-labeled detection rule with the tactics and the techniques corresponding to a matched one of the keywords.

3. The labeling method according to claim 1, wherein the step of classifying the reference documents according to the tactic and technique to which the reference documents belong to, to generate the plurality of corpuses further comprises:
performing a first data preprocessing step to, according to technical platforms provided in the reference documents, select the reference documents corresponding to the plurality of technical items that are suitable for labeling types of detection rules;
performing a TTP text grouping step to combine the reference documents of all the technical items belonging to the same tactic and then categorize the combined reference documents according to the corresponding tactics to generate the plurality of corpuses.

4. The labeling method according to claim 1, wherein the step of obtaining the field content of the extracted at least one key information field further comprises:
performing a second data preprocessing step on the at least one key information field and the reference documents in the corpuses to delete stop words and perform a lemmatisation.

5. The labeling method according to claim 4, wherein the second data preprocessing step further comprises converting acronyms related to information security into complete terms.

6. The labeling method according to claim 3, wherein the step of obtaining the field content of the extracted at least one key information field further comprises:
executing a first term frequency-inverse document frequency (TF-IDF) vectorizer to calculate, for words in each text in the field content of the plurality of to-be-labeled detection rules and the corpuses, importance of the words in the corresponding texts, and to covert the calculated importance into feature vectors corresponding to each of the texts, so as to obtain a plurality of first rule feature vectors of the plurality of to-be-labeled detection rules and a plurality of first TTP feature vectors of the plurality of corpuses.

7. The labeling method according to claim 1, wherein the step of using the labeled detection rules and the corpuses as the training data set further comprises:
executing a second TF-IDF vectorizer to calculate, for words in each text in the field content of the labeled detection rules and the corpuses, importance of the words in the corresponding texts, and to covert the calculated importance into feature vectors corresponding to each of the texts, so as to obtain a plurality of second rule feature vectors of the labeled detection rules and a plurality of second TTP feature vectors of the plurality of corpuses, which are used to train the to-be-trained TTP labeling model.

8. The labeling method according to claim 7, wherein the to-be-trained TTP labeling model is a machine learning classification algorithm, during training of the machine learning classification algorithm, each of the second rule feature vectors is compared with the second TTP feature vectors to calculate text similarities, and the labeled detection rules are labeled with the text corresponding to the second TTP feature vector with a highest one of the text similarities, so as to feed back a training result.

9. A tactic, technique and procedure (TTP) labeling device for information security detection rules, the TTP labeling device comprising:
a processor; and
a storage unit electrically connected to the processor, wherein the processor is configured to perform the following steps:
obtaining a plurality of reference documents related to definitions of TTP, and classifying the reference documents according to tactic and technique to which the reference documents belong to, so as to generate a plurality of corpuses, wherein the plurality of corpuses include a plurality of tactics and a plurality of techniques categorized according to the plurality of tactics;
creating a keyword thesaurus that includes a plurality of keywords, wherein tactics and techniques respectively corresponding to the plurality of keywords are defined in the keyword thesaurus;
obtaining a plurality of to-be-labeled detection rules, and performing the following steps for the plurality of to-be-labeled detection rules to generate a plurality of labeled detection rules:
extracting at least one key information field from the plurality of to-be-labeled detection rules;
comparing the at least one key information field with the plurality of keywords, so as to label the plurality of to-be-labeled detection rules;
for the to-be-labeled detection rules that are not labeled, obtaining field content of the extracted at least one key information field, and performing a text similarity calculation on the field content and the plurality of corpuses to obtain a plurality of text similarities between the plurality of corpuses and the field content; and
labeling the to-be-labeled detection rules that are not labeled with the tactics and the techniques corresponding to the corpus having a highest one of the text similarities;
using the labeled detection rules and the corpuses as a training data set, training a to-be-trained TTP labeling model to generate a TTP labeling model; and
inputting a current to-be-labeled detection rule into the TTP labeling model to generate a TTP labeling result, and updating the corpuses with the TTP labeling result.

10. The TTP labeling device according to claim 9, wherein the processor is further configured to perform:
performing a rules-based labeling step for each of the plurality of to-be-labeled detection rules, so as to compare the at least one key information field with the plurality of keywords; and in response to any one of the plurality of keywords matching the at least one key information field, labeling the to-be-labeled detection rule with the tactics and the techniques corresponding to a matched one of the keywords.

11. The TTP labeling device according to claim 9, wherein the step of classifying the reference documents according to the tactic and technique to which the reference documents belong to, to generate the plurality of corpuses further comprises:
performing a first data preprocessing step to, according to technical platforms provided in the reference documents, select the reference documents corresponding to the plurality of technical items that are suitable for labeling types of detection rules;
performing a TTP text grouping step to combine the reference documents of all the technical items belonging to the same tactic and then categorize the combined reference documents according to the corresponding tactics to generate the plurality of corpuses.

12. The TTP labeling device according to claim 9, wherein the step of obtaining the field content of the extracted at least one key information field further comprises:
performing a second data preprocessing step on the at least one key information field and the reference documents in the corpuses to delete stop words and perform a lemmatisation.

13. The TTP labeling device according to claim 12, wherein the second data preprocessing step further comprises converting acronyms related to information security into complete terms.

14. The TTP labeling device according to claim 11, wherein the step of obtaining the field content of the extracted at least one key information field further comprises:
executing a first term frequency-inverse document frequency (TF-IDF) vectorizer to calculate, for words in each text in the field content of the plurality of to-be-labeled detection rules and the corpuses, importance of the words in the corresponding texts, and to covert the calculated importance into feature vectors corresponding to each of the texts, so as to obtain a plurality of first rule feature vectors of the plurality of to-be-labeled detection rules and a plurality of first TTP feature vectors of the plurality of corpuses.

15. The TTP labeling device according to claim 9, wherein the step of using the labeled detection rules and the corpuses as the training data set further comprises:
executing a second TF-IDF vectorizer to calculate, for words in each text in the field content of the labeled detection rules and the corpuses, importance of the words in the corresponding texts, and to convert the calculated importance into feature vectors corresponding to each of the texts, so as to obtain a plurality of second rule feature vectors of the labeled detection rules and a plurality of second TTP feature vectors of the plurality of corpuses, which are used to train the to-be-trained TTP labeling model.

16. The TTP labeling device according to claim 15, wherein the to-be-trained TTP labeling model is a machine learning classification algorithm, during training of the machine learning classification algorithm, each of the second rule feature vectors is compared with the second TTP feature vectors to calculate text similarities, and the labeled detection rules are labeled with the text corresponding to the second TTP feature vector with a highest one of the text similarities, so as to feed back a training result.
